(19) United States
(12) Patent Application Publication
(10) Pub. No.: US 2006/0290575 A1
(43) Pub. Date: Dec. 28, 2006

(54) Antenna integrated into a housing

(76) Inventor: Heiko Pelzer, Erkelenz (DE)

Correspondence Address: PHILIPS INTELLECTUAL PROPERTY & STANDARDS, P.O. BOX 3001, BRIARCLIFF MANOR, NY, 10510, US

(21) Appl. No.: 10/555,746

(22) PCT Filed: Apr. 29, 2004
(86) PCT No.: PCT/IB04/01448

§ 371 Date: Nov. 4, 2005

(30) Foreign Application Priority Data
May 9, 2003 (EP) 03101287.5

(51) Int. Cl. H01Q 1/24

(52) U.S. Cl. 343/702

(57) ABSTRACT

The invention relates to at least one antenna that is integrated into the housing of a device and that has a substrate, a resonant printed conductor structure and a first and a second contact pin. The first contact pin is connected to a ground potential in this case and the second contact pin is provided to give an infeed of high frequency to a printed circuit board. The invention further relates to a device having, integrated into its housing, two antennas that can be driven separately from one another. It is particularly advantageous in the case of this embodiment that there is an increase in bandwidth, particularly in the 2 GHz range, due to the presence of the other antenna in the given case.

The invention relates to a telecommunications device having at least one antenna integrated into its housing.

In mobile telecommunications, electromagnetic waves in the microwave range are used for transmitting information. Examples of this are the GSM mobile telephone standards in the frequency range from 890 to 960 MHz (GSM900), from 1710 to 1880 MHz (GSM1800 or DCS) and from 1850 to 1990 MHz (GSM1900 or PCS), and also, in the next generation, the UMTS band (1885 to 2200 MHz) and the Bluetooth standard in the frequency range from 2400 to 2480 MHz, which are used to allow data to be exchanged between, for example, mobile telephones and other electronic devices such as, for example, computers, other mobile telephones, and so on.

Because current applications within the GSM frequency ranges will have to be kept in being until around 2010, it will have to be possible for terminals, particularly those that come onto the market in the next few years, to be operated in both the GSM and the UMTS frequency ranges. At the same, a trend can be seen towards internal antennas. The amount of space available is also going to become smaller due to the additional functions that will have to be incorporated, because the next generation of mobile telephones will probably not be any larger than those that exist today. Antennas that are smaller but, at the same time, of higher performance are required. What can also be seen is that the electrical environment has a significant impact on performance. Consequently, it is not only the size of the antenna that is important but also the need for it to be matched in an application, which is one of the things that is a major co-determinant of the effective size of an antenna configuration.

The antennas used radiate electromagnetic energy and do so by setting up an electromagnetic resonance. The length of the antenna has to be equal to at least a quarter of the wavelength of the radiation transmitted in this case. With air as a dielectric (εᵣ=1), the length obtained for the antenna, for frequencies of 1 GHz, is thus 75 mm. The length of the antenna can be reduced, for example, by winding the wire of the antenna in the shape of a helix in so-called stub antennas.

To minimize the size of the antenna, for emitted radiation of a given wavelength, a dielectric having a dielectric constant εᵣ>1 can be used as a basic building block for the antenna. This leads to the wavelength of the radiation being reduced in the dielectric by a factor of 1/\sqrt{εᵣ}. The size of an antenna designed on the basis of a dielectric of this kind therefore likewise becomes smaller by this factor.

An antenna of this kind comprises a block (substrate) of dielectric material. Applied to the surfaces of this substrate are, depending on the desired operating frequency band or bands, one or more resonant metallized structures. The values of the resonant frequencies are dependent on the dimensions of the printed metallized structure and on the value of the dielectric constant of the substrate. The values of the individual resonant frequencies go down in this case as the length of the metallized structures increases and as the value of the dielectric constant goes up. Antennas of this kind are also called printed wire antennas (PWAs) or dielectric block antennas (DBAs) and are disclosed in, for example, EP 1195845 A2 and EP 1204160 A2.

The ease with which the antenna can be fitted is an advantage. To do this, the antenna is applied direct to a printed circuit board (PCB) by surface mounting (the SMD technique), i.e. by soldering and making of contact flat to the board, together with other components if required. A further advantage is the low height of the antenna.

However, something that is disadvantageous about these antennas is the fact that they require a relatively large amount of space on the printed circuit board and thus have a considerable effect on the design of the board. For example, there must not be any grounding metallization underneath the antenna, because this would have an adverse effect on both the input and output attributes of the antenna.

It is an object of the invention to provide an antenna that can be integrated into a device with as much space saved as possible.

This object is achieved by an antenna that is integrated into the housing of a device and that has

at least one substrate

at least one resonant printed conductor structure

at least one first and one second contact pin,

the first contact pin being connected to a ground potential and the second contact pin being provided to give an infeed of high frequency to a printed circuit board.

An advantage of this solution is that no special clear space is required for the antenna on a printed circuit board within the device, and the design of the printed circuit board no longer has to be adjusted to suit the positioning of the antenna on the printed circuit board. What is particularly advantageous is the fact that the area available for the design of the resonant structure can be enlarged because no soldered contact points are required for fixing the antenna in place. At the same time, the effect on the design of the printed circuit board is considerably reduced.

In the embodiment claimed in claims 2 to 4, a first printed conductor structure belonging to the antenna is connected via a first contact point to a ground potential of the printed circuit board. At the same time, a second printed conductor on the printed circuit board is connected via a second contact point to a second printed conductor structure belonging to the antenna. The antenna may also have further printed conductor structures, which are not in contact with the printed circuit board and by which further resonances can be produced.

The first and second printed conductor structures begin at the first and second contact points respectively and end at separate respective end-points. The individual length (lᵢ) of an individual printed conductor structure corresponds in this case to approximately half the wavelength of the resonant frequency (fᵢ). The individual length (lᵢ) is equal to approximately:

$${l}_{i} ≅ \frac{{λ}_{i}}{2 \sqrt{{ɛ}_{r}}}$$

The invention also relates to a device having at least one antenna integrated into its housing. The antenna has at least one first and one second resonant printed conductor structure, which structures are connected via a first point of connection to a first printed conductor on a printed circuit board. The antenna has at least two further points of connection by means of which two further printed conductors on the printed circuit board are provided as connections for the antenna.

In the embodiment claimed in claims 7 to 9, at least two antennas, which can be driven separately from one another, are integrated into the housing of the device. What is particularly advantageous about this embodiment is that, because of the presence of the other antenna in the given case, an increase occurs in the bandwidth, particularly in the 2 GHz range.

With regard to the receiving characteristics, use may be made, for example, of what is termed polarization diversity as a result of there being a sub-module composed of the first and second antennas. What polarization diversity means is that the two antennas do not receive electromagnetic radiation of different polarizations equally well, which means that, depending on the position of the device (e.g. a mobile telephone), one of the two antennas gives better reception. The transmitting properties and, in this connection, directivity in particular, can be actively influenced by driving the two antennas simultaneously but varying the phase shift between the signals. This gives an opportunity of orienting the maximum level of radiation from the antenna in the direction that points away from the head of a user. Because of the very small dimensions of the antennas, an acceptable isolation of at least 10 dB is obtained between them.

The invention also relates to a printed circuit board (PCB) having at least one antenna of this kind that is integrated into the housing of a device and connected to the printed circuit board via contact pins.

These and other aspects of the invention are apparent from and will be elucidated with reference to the embodiments described hereinafter.

In the drawings:

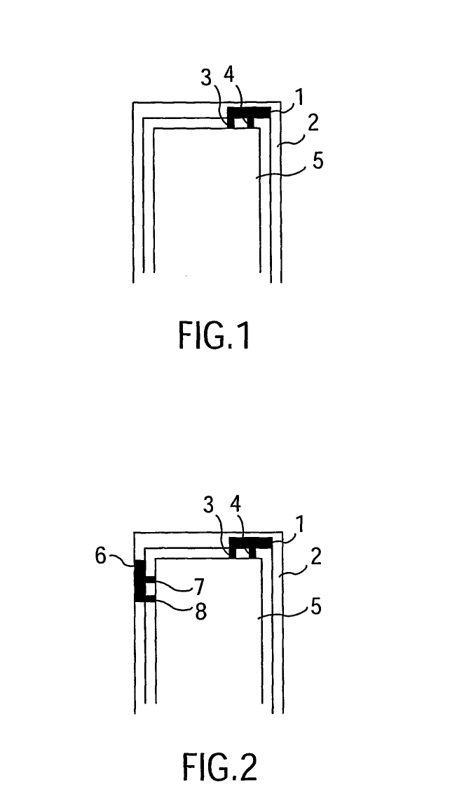

FIG. 1 shows a first antenna integrated into the housing of a device.

FIG. 2 shows a so-called diversity antenna sub-module comprising two dielectric block antennas (DBAs).

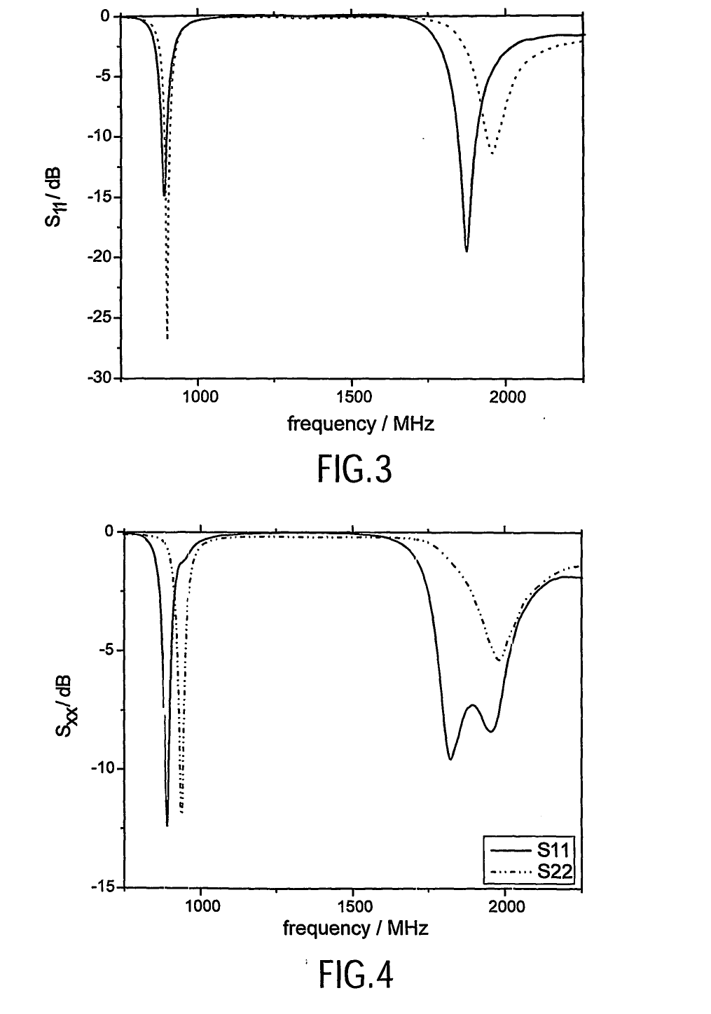

FIG. 3 is a representation of the curve followed by the S₁₁ parameter of the first embodiment of antenna.

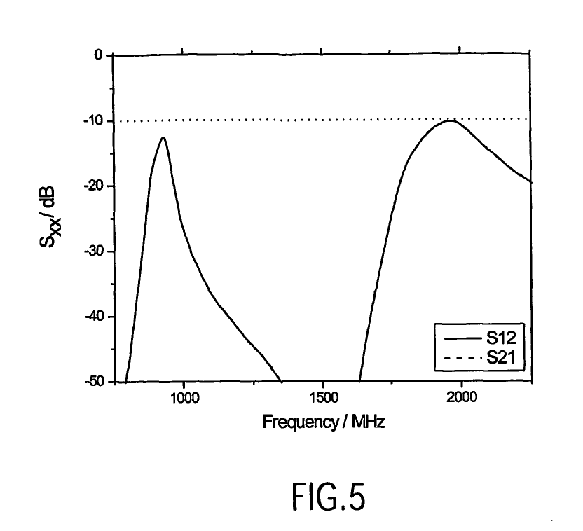

FIG. 4 is a representation of the curve followed by the S₁₁ parameter of the second embodiment of antenna.

In FIG. 1 is shown a first embodiment of the first antenna 1 according to the invention that is integrated into the housing 2. The antenna 1 is connected via contact pins 3 and 4 to a printed circuit board 5. The contact pins 3 and 4 are situated approximately halfway up the antenna 1, and the antenna 1 is thus centrally arranged relative to the printed circuit board 5.

The antenna 1 is a multiband antenna and comprises a ceramic substrate in the form of a substantially parallelepiped block whose size is approximately 17*13*2 mm³. What is used as a substrate material is a carrier material that has a dielectric constant or relative permeability greater than 1. Typical materials are substrates suitable for high-frequency use that have low losses and whose high-frequency characteristics are to only a small degree dependent on temperature (NPO or so-called SL materials). What may also be used are substrates that have a dielectric constant εᵣ and relative permeability μᵣ other than 1 as a result of a ceramic powder being embedded in a polymer matrix.

Rather than a parallelepiped substrate, there are also other geometrical shapes that are possible such as, for example, a cylindrical shape, to which the appropriate printed conductor structures are applied. The substrate should, however, be as shallow as possible to ensure that it can easily be integrated into the housing, as shown in FIG. 1, for example.

The antenna has two electrical connections: the first connection A is in contact with the ground electrode of the application (e.g. a telecommunications terminal) and comprises a first contact pin 3. The second connection B is in contact with the high-frequency feed line (generally 50 Ω) to the printed circuit board 5 and likewise comprises a contact pin, the second contact pin 4. The two connections form respective terminal points of metallization which extends onwards from them and whose width may vary. Branching off from connection A is metallization whose overall length defines the lowest resonant frequency (e.g. GSM900). The first harmonic, which can be shifted into the desired band (e.g. DCS1800) by certain coupling mechanisms, determines a further frequency band in which the antenna is able to operate effectively. Other resonances can be produced by additional areas of metallization that have no conductive connection to the high-frequency feed line or to the ground metallization.

The metallized structures of the antenna are composed of a material of high electrical conductivity such as, for example, silver, copper, gold, aluminum or a superconductor.

In FIG. 2, the same parts are identified by the same reference numerals. In a second embodiment, which is shown in FIG. 2, a so-called diversity antenna sub-module comprises two dielectric block antennas (DBAs) 1 and 6 that are mounted on the printed circuit board 5. The second antenna 6 too is connected to the printed circuit board 5, via contact pins 7 and 8. In the embodiment shown in FIG. 2, the first antenna 1 and the second antenna 2 are of the same construction.

This embodiment also has the advantage that the two antennas 1 and 6 can be driven separately from one another. Because of the presence of the other antenna in the given case, there is an increase in bandwidth, particularly in the 2 GHz range. With regard to receiving characteristics, use can be made, for example, by this sub-module of what is termed polarization diversity. The two antennas are not equally good at receiving electromagnetic radiation of different polarizations in this case, which means that, depending on the position of the mobile telephone, one of the two antennas gives better reception. The transmitting properties and, in this connection, directivity in particular, can be actively influenced by driving the two antennas simultaneously but varying the phase shift between the signals. This gives an opportunity of orienting the maximum level of radiation from the antenna in the direction that points away from the head of the user. Because the antennas 1 and 6 are very small, an acceptable isolation of at least 10 dB is also obtained between them. What is more, a plurality of frequency bands can be covered by making slight variations in the design of the individual antennas (e.g. AMPS+DCS covered by antenna 1 and GSM 900+PCS covered by antenna 2).

Shown in FIG. 3 are the input characteristics of the antenna 1, in the form of its S₁₁ parameter for two different positions of the antenna 1 on the printed circuit board 5. The solid line is the curve for the S₁₁ parameter of the antenna 1 shown in FIG. 1 that is mounted at the shorter side of the printed circuit board, while the dashed line is the curve for the S₁₁ parameter of the same antenna 1 but in a case where it is mounted at the longer side of the printed circuit board.

In both positions, the antenna has a resonance in the region of the GSM 900 frequency band. However, the point at which the upper resonance is situated in terms of frequency depends on whether the antenna is mounted at the shorter side of the printed circuit board or at its longer side. In the first case, the resonance is situated in the DCS frequency band and in the second case it is situated in the region of the PCS frequency band and parts of the UMTS band. These frequency shifts can be compensated for or removed by slight variations in design.

In FIG. 4 is shown the measured S₁₁ parameter (the solid line) of the diversity antenna sub-module seen in FIG. 2. The dotted-and-dashed line is the curve for the S₂₂ parameter of the diversity antenna sub-module. The curves clearly shown that the interaction between the antennas 1 and 6 is responsible for an increase in bandwidth in the DCS/PCS spectrum (1850 to 1990 MHz) and parts of the UMTS spectrum (1885 to 2200 MHz).

The antennas of the diversity antenna sub-module are matched in such a way that the resonance of the antenna 1 (S₁₁) mounted at the shorter side gives optimum coverage of the Tx (transmission) range in the region of the GSM 900 frequency band, whereas the antenna 2 (S₂₂) mounted at the longer side of the printed circuit board is optimized for the Rx (reception) range. If an optimization of this kind for the parts of the frequency range is not carried out, the resonances almost overlay one another, thus enabling optimum use to be made of the diversity principle described above. In the upper frequency range, the DCS frequency band is covered by antenna 2. On the other hand, due to the enlargement of bandwidth, both the antennas are resonant in the PCS frequency band and parts of the UMTS frequency band, thus enabling use to be made of the diversity principles mentioned in this frequency range.

In FIG. 5 is shown the isolation measured between the antennas of the diversity antenna sub-module. The isolation is better than −100 dB even though, at 900 MHz, the distance between the antennas is considerably less that a quarter of the wavelength.

1. An antenna that is integrated into the housing of a device, having
at least one substrate
at least one resonant printed conductor structure
at least one first and one second contact pin,
the first contact pin being connected to a ground potential and the second contact pin being provided to give an infeed of high frequency to a printed circuit board.

2. An antenna as claimed in claim 1, characterized in that the first and second contact pins are connected to respective printed conductor structures via contact points.

3. An antenna as claimed in claim 1, characterized in that the first contact pin is connected to a first resonant printed conductor structure via a first contact point and the length of the first resonant printed conductor structure is tuned to a first frequency band.

4. An antenna as claimed in claim 1, characterized in that the antenna has a further printed conductor structure that is not in contact with the printed circuit board.

5. An antenna as claimed in claim 1, characterized in that the contact pins are in the form of spring pins.

6. A device, having integrated into its housing a first antenna having
at least one substrate
at least one resonant printed conductor structure
at least one first and one second contact pin,
the first contact pin being connected to a ground potential and the second contact pin being provided to give an infeed of high frequency.

7. A device as claimed in claim 6, characterized in that at least one first antenna and one second antenna are provided in the housing for transmitting or receiving.

8. A device as claimed in claim 7, characterized in that the first and second antennas (1 and 6) are driven separately from one another.

9. A device as claimed in claim 7, characterized in that the contacts made by the first antenna and the second antenna are at two different sides of the printed circuit board.

10. A device as claimed in claim 7, characterized in that the first antenna and/or the second antenna is provided in the form of a passive resonant structure.

11. A printed circuit board, particularly for the surface mounting of electronic components, having an antenna as claimed in claim 1.
